(19) United States
(12) Patent Application Publication
(10) Pub. No.: US 2026/0311512 A1
(43) Pub. Date: Oct. 8, 2026

(54) ACTION ANTICIPATION

(71) Applicant: HONDA MOTOR CO., LTD., Tokyo (JP)

(72) Inventors: Nakul AGARWAL, San Francisco, CA (US); Vinay PURUSHOTHAM, Urbana, IL (US); Enna SACHDEVA, Santa Clara, CA (US); Pero SUBASIC, San Jose, CA (US); Kikuo FUJIMURA, Palo Alto, CA (US); Vikrant NAGPURE, Tokyo (JP); Kenji OKUMA, Tokyo (JP); Makoto MOCHIZUKI, Yokohama (JP)

(21) Appl. No.: 19/465,662

(22) Filed: Jan. 30, 2026

Related U.S. Application Data
(60) Provisional application No. 63/782,269, filed on Apr. 2, 2025.

(51) Int. Cl. G06V 40/20; G06T 7/73; G06V 20/59; G06V 40/10

(52) U.S. Cl. CPC G06V 40/20; G06T 7/73; G06V 20/59; G06V 40/10; G06T 2207/30201; G06T 2207/30268

(57) ABSTRACT

According to one aspect, action anticipation may include generating a gaze embedding associated with a gaze, a pose embedding associated with a pose, and an object embedding associated with an object from an input set of image frames. The computer-implemented method for action anticipation may include generating a joint cue based on the gaze embedding and the pose embedding and a global context token based on the gaze embedding and the object embedding. The computer-implemented method for action anticipation may include generating an anticipated human-object-interaction (HOI) based on a model, the joint cue, and the global context token. The model may be trained using ground truth data including HOI triplet annotations.

### CROSS-REFERENCE TO RELATED APPLICATIONS

This application claims the benefit of U.S. Provisional Patent Application, Ser. No. 63/782,269 (Attorney Docket No. H1251053US01) entitled “DRIVER ACTION ANTICIPATION INSIDE CAR CABIN USING SPATIO-TEMPORAL TRANSFORMERS WITH GAZE AND POSE CUES”, filed on Apr. 2, 2025; the entirety of the above-noted application(s) is incorporated by reference herein.

### BACKGROUND

Artificial intelligence (AI) is the science and engineering of creating machines and systems that may perform tasks that normally require human intelligence, such as learning, reasoning, and decision making. AI algorithms are the rules and procedures that guide the behavior of AI systems, such as neural networks, natural language processing, computer vision, and machine learning. AI algorithms may be used to analyze large amounts of data, recognize patterns, generate predictions, and optimize outcomes. However, AI algorithms also have limitations, especially when it comes to predicting human behavior, which is complex, dynamic, and context-dependent.

### BRIEF DESCRIPTION

According to one aspect, a system for action anticipation may include a memory and a processor. The memory may store one or more instructions. The processor may execute one or more of the instructions stored on the memory to perform one or more acts, actions, and/or steps. The processor may perform generating a gaze embedding associated with a gaze of an individual, a pose embedding associated with a pose of the individual, and an object embedding associated with an object from an input set of image frames. The processor may perform generating a joint cue based on the gaze embedding and the pose embedding and a global context token based on the gaze embedding and the object embedding. The processor may perform generating an anticipated human-object-interaction (HOI) based on a model, the joint cue, and the global context token. The model may be trained using ground truth data including HOI triplet annotations.

The processor may generate the gaze embedding based on tracking information associated with the object from the object embedding. The pose embedding may include a learned embedding component and a positional embedding component. The positional embedding component may represent a spatial location associated with a keypoint of the individual. The learned embedding component may represent a type of keypoint associated with a keypoint of the individual. The processor may generate the joint cue by concatenating the gaze embedding and the pose embedding. The joint cue may represent an attention and a body configuration of the individual. The model may include a spatial encoder and a temporal encoder. The spatial encoder may refine a human-object pair representation through self-attention from the input set of image frames on a frame-by-frame basis. The temporal encoder may build an instance-level sliding window including a historical representation of the human-object pair representation.

According to one aspect, a computer-implemented method for action anticipation may include generating a gaze embedding associated with a gaze of an individual, a pose embedding associated with a pose of the individual, and an object embedding associated with an object from an input set of image frames. The computer-implemented method for action anticipation may include generating a joint cue based on the gaze embedding and the pose embedding and a global context token based on the gaze embedding and the object embedding. The computer-implemented method for action anticipation may include generating an anticipated human-object-interaction (HOI) based on a model, the joint cue, and the global context token. The model may be trained using ground truth data including HOI triplet annotations.

The pose embedding may include a learned embedding component and a positional embedding component. The positional embedding component may represent a spatial location associated with a keypoint of the individual. The learned embedding component may represent a type of keypoint associated with a keypoint of the individual. The computer-implemented method for action anticipation may include generating the joint cue by concatenating the gaze embedding and the pose embedding. The model may include a spatial encoder and a temporal encoder. The spatial encoder may refine a human-object pair representation through self-attention from the input set of image frames on a frame-by-frame basis. The temporal encoder may build an instance-level sliding window including a historical representation of the human-object pair representation. The computer-implemented method for action anticipation may include enabling a feature of a vehicle or actuating an actuator based on the anticipated HOI.

According to one aspect, a system for action anticipation may include a memory and a processor. The memory may store one or more instructions. The processor may execute one or more of the instructions stored on the memory to perform one or more acts, actions, and/or steps. The processor may perform generating a gaze embedding associated with a gaze of an individual, a pose embedding associated with a pose of the individual, and an object embedding associated with an object from an input set of image frames. The processor may perform generating a joint cue based on the gaze embedding and the pose embedding and a global context token based on the gaze embedding and the object embedding. The joint cue may represent an attention and a body configuration of the individual. The processor may perform generating an anticipated human-object-interaction (HOI) based on a model, the joint cue, and the global context token. The model may be trained using ground truth data including HOI triplet annotations.

### BRIEF DESCRIPTION OF THE DRAWINGS

FIG. 1 is an exemplary component diagram of a system for action anticipation, according to one aspect.

FIG. 2 is an exemplary flow diagram of a computer-implemented method for action anticipation, according to one aspect.

FIG. 3 is an exemplary illustration of an architecture for the system for action anticipation of FIG. 1, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “controller”, as used herein, may be a device implemented in hardware, firmware, software, or a combination thereof. A controller may include one or more CPUs (e.g., a central processing unit including one or more “processors”), a “memory”, a “storage drive”, a “bus”, and one or more programmable input/output (I/O) peripherals.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

Understanding and anticipating human-object-interactions (HOIs) is useful for enhancing intelligent systems in human-centric environments. While recent research has focused on detecting interactions in general-purpose videos, a particularly impactful application arises in in-cabin automotive scenarios, where anticipating occupants' interactions with car components (e.g., doors, lights, buttons, or infotainment systems) may greatly improve user experience, and automation.

The system for action anticipation may adopt and extend recent advances in video-based HOI anticipation to the in-cabin domain. The system for action anticipation may utilize a spatio-temporal transformer model leveraging human gaze features for predicting future interactions to detect and anticipate interactions inside vehicles, by incorporating pose information and training the model on a custom dataset with various action sequences that have real use cases for the in-cabin application.

Action anticipation enables the vehicle to proactively offer smart services, such as unlocking doors, adjusting lighting, or preparing the infotainment system, thus creating a smoother driving experience. This application presents unique challenges, such as the confined space of vehicle cabins, the rapid nature of human actions, and real-time response.

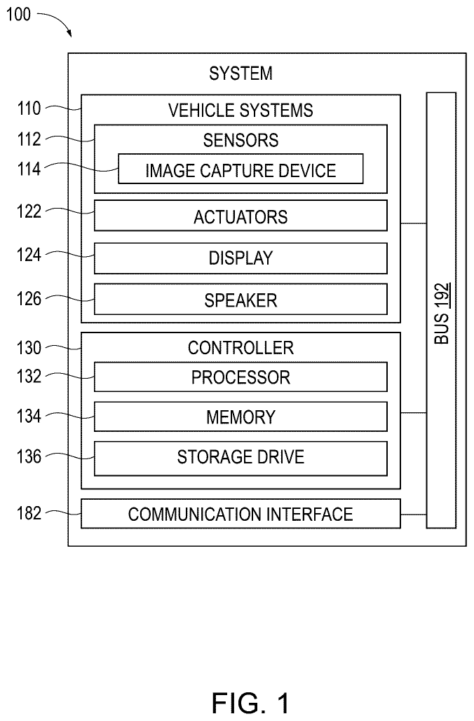

FIG. 1 is an exemplary component diagram of a system 100 for action anticipation, according to one aspect. The system 100 for action anticipation may include one or more vehicle systems 110. One or more of the vehicle systems 110 may include one or more sensors 112, such as an image capture device 114, for example. The system 100 for action anticipation may include one or more actuators 122. According to one aspect, one or more of the actuators 122 may be included in one or more vehicle systems 110. The system 100 for action anticipation may include a display 124, a speaker 126, one or more input/output (I/O) devices, etc. The system 100 for action anticipation may include a controller 130. The controller 130 may include a processor 132, a memory 134, and a storage drive 136. The system 100 for action anticipation may include a communication interface 182 and a bus 192. The bus 192 may form an operable connection between one or more components (e.g., vehicle systems 110, actuators 122, display 124, speaker 126, controller 130, communication interface 182, etc.) of the system 100 for action anticipation and enable computer communication therebetween.

The memory 134 may store one or more instructions. The processor 132 may execute one or more of the instructions stored on the memory 134 to perform one or more acts, actions, and/or steps. As discussed above, a “vehicle system” may include any automatic or manual systems that may enhance operation the vehicle, and/or the driving experience. According to one aspect, the system 100 for action anticipation may be equipped on a vehicle. According to another aspect, the system 100 for action anticipation may be remote from the vehicle and one or more of the acts, actions, and/or steps may be performed remote from the vehicle and transmitted to the communication interface 182 of the vehicle for implementation.

The sensors 112 may include the image capture device 114. The image capture device 114 may capture an input set of image frames. The input set of image frames may include an individual in an environment and an object in the environment.

The processor 132 may perform generating a gaze embedding associated with a gaze of the individual, a pose embedding associated with a pose of the individual, and an object embedding associated with the object from the input set of image frames received, sensed, or detected by the image capture device 114. According to one aspect, the communication interface 182 may receive the input set of image frames from an image capture device 114 of a mobile device, for example.

The processor 132 may generate the gaze embedding based on tracking information associated with the object from the object embedding.

The pose embedding may include a learned embedding component and a positional embedding component. The positional embedding component may represent a spatial location associated with a keypoint of the individual. The learned embedding component may represent a type of keypoint associated with a keypoint of the individual.

The processor 132 may perform generating a joint cue based on the gaze embedding and the pose embedding and a global context token based on the gaze embedding and the object embedding. The processor 132 may generate the joint cue by concatenating the gaze embedding and the pose embedding. The joint cue may represent an attention and a body configuration of the individual.

The processor 132 may perform generating an anticipated human-object-interaction (HOI) based on a model, the joint cue, and the global context token. The model may be trained using ground truth data including HOI triplet annotations.

According to one aspect, the HOI triplet annotations may include a video or set of image frames where human subjects perform various action sequences in a vehicle cabin. For each video, the human bounding boxes, object bounding boxes, human pose key-points, and HOI triplets for all frames may be provided or annotated. In this way, the problem of action anticipation from the input set of image frames may be formulated as a HOI anticipation problem.

Example object classes may include a steering wheel, a human, a parking gear, a seatbelt, an engine button, a door, a driver seat, a laptop, a bag, etc.

Example action classes may include driving, reaching, operating, retracting, removing, turning towards, doing nothing, grabbing, holding, opening, closing, putting down, etc.

Example triplet classes may include human-driving-steering wheel, human-reaching-parking gear, human-operating-parking gear, human-retracting-parking gear, human-removing-seatbelt, human-reaching-engine button, human-operating-engine button, human-retracting-engine button, human-turning towards-user door, human-doing nothing-driver seat, human-reaching-laptop, human-grabbing-laptop, human-holding-laptop, human-opening-laptop, human-operating-laptop, human-closing-laptop, human-putting down-laptop, human-retracting-laptop, human-reaching-bag, human-grabbing-bag, human-holding-bag, human-putting down-bag, human-retracting-bag, etc.

The model may include a spatial encoder and a temporal encoder. The spatial encoder may refine a human-object pair representation through self-attention from the input set of image frames on a frame-by-frame basis. The temporal encoder may build an instance-level sliding window including a historical representation of the human-object pair representation. According to one aspect, the communication interface 182 may receive the model and store the model on the storage drive 136 of the system 100 for action anticipation.

One or more of the vehicle systems 110, actuators 122, display 124, speaker 126, etc. may be activated, deactivated, provide a service, etc. based on the anticipated human-object-interaction (HOI). For example, the doors or windows or trunk of the vehicle may be locked, unlocked, opened, closed, the engine started, navigation engaged or disengaged, autonomous driving engaged or disengaged, etc. based on the anticipated HOI. According to another example, action anticipation may include enabling or disabling a feature of the vehicle or actuating the actuator based on the anticipated HOI. In this way, the benefit or advantage of a seamless driving or operating experience is provided by predicting the anticipated HOI.

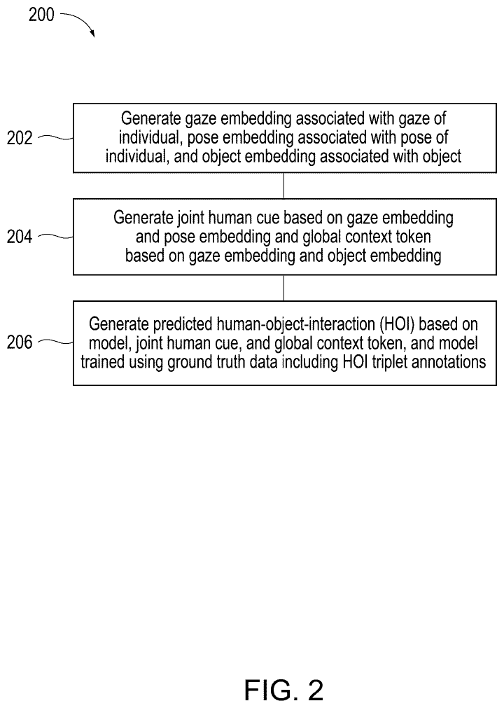

FIG. 2 is an exemplary flow diagram of a computer-implemented method for action anticipation, according to one aspect. The computer-implemented method for action anticipation may include generating 202 a gaze embedding associated with a gaze of an individual, a pose embedding associated with a pose of the individual, and an object embedding associated with an object from an input set of image frames. The computer-implemented method for action anticipation may include generating 204 a joint cue based on the gaze embedding and the pose embedding and a global context token based on the gaze embedding and the object embedding. The computer-implemented method for action anticipation may include generating 206 an anticipated human-object-interaction (HOI) based on a model, the joint cue, and the global context token. The model may be trained using ground truth data including HOI triplet annotations.

The pose embedding may include a learned embedding component and a positional embedding component. The positional embedding component may represent a spatial location associated with a keypoint of the individual. The learned embedding component may represent a type of keypoint (e.g., left shoulder, right wrist) associated with a keypoint of the individual. The computer-implemented method for action anticipation may include generating the joint cue by concatenating the gaze embedding and the pose embedding. The model may include a spatial encoder and a temporal encoder. The spatial encoder may refine a human-object pair representation through self-attention from the input set of image frames on a frame-by-frame basis. The temporal encoder may build an instance-level sliding window including a historical representation of the human-object pair representation. The computer-implemented method for action anticipation may include enabling a feature of a vehicle or actuating an actuator based on the anticipated HOI.

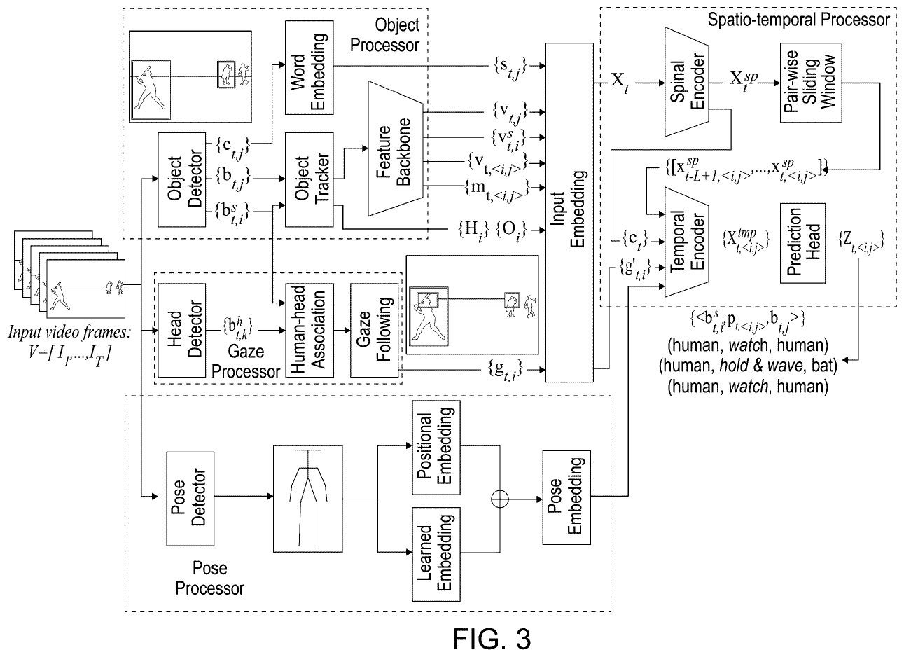

FIG. 3 is an exemplary illustration of an architecture for the system for action anticipation of FIG. 1, according to one aspect. According to one aspect, a Gaze-Augmented Spatio-Temporal Transformer for HOI detection and anticipation may be utilized and extended by integrating a pose processor designed to capture human body configurations. The full framework may include an object processor, a gaze processor, a pose processor, and a spatiotemporal transformer for temporal modeling and prediction.

### Object Processor

The object processor may be responsible for detecting and tracking humans and objects throughout the video. The object processor may include a pre-trained object detector (e.g., YOLOv9) that first localizes humans and objects in each frame. According to another aspect, the object processor may be trained using at least some of the ground truth data including HOI triplet annotations. These detections are then temporally associated using DeepSORT to construct trajectories. For each human-object pair, the object processor may extract visual appearance features from the bounding boxes of both the human and the object, a visual relation feature from their union region, and a spatial relation mask encoding their relative spatial layout. Additionally, the object class may be embedded using a pre-trained word embedding model. All features are projected into a unified feature space and are subsequently used as inputs to the transformer.

### Gaze Processor

The gaze processor may estimate human attention in the scene. Human heads may be detected using a dedicated head detector, followed by a human-head association algorithm that assigns heads to humans. A gaze-following network may predict a gaze heatmap for each human, capturing the likely region of visual attention. The resulting heatmaps may be processed via a convolutional neural network (CNN) to yield compact gaze feature vectors.

### Pose Processor

To explicitly model human body posture, a pose processor may be provided. The pose estimator may detect K 2D keypoints per human, with each keypoint denoted as (xₖ, yₖ). The coordinates may be normalized to lie within [0, 1]. Each keypoint may be encoded as the sum of a 64-dimensional sinusoidal positional embedding, capturing its spatial location, and a learned embedding representing the keypoint type (e.g., left shoulder, right wrist). Formally, the keypoint embedding may be defined as:

$${e}_{k} = P E ( {x}_{k} , {y}_{k} ) + L {E}_{type} ( k ) ,$$

where PE(·) is the positional encoding and LE_{type} (·) is the learned key-point type embedding. The resulting set of keypoint embeddings may be flattened into a pose vector. The pose processor may concatenate this pose vector with the human's gaze feature to obtain a joint cue that combines information about both attention and body configuration.

### Spatio-Temporal Transformer

The spatial encoder of the spatio-temporal transformer may operate on each frame individually, refining human-object pair representations through self-attention while extracting a global context token summarizing the scene. The temporal encoder of the spatio-temporal transformer may build instance-level sliding windows, each containing the historical representations of a specific human-object pair. Further, the joint cue and the global context token may be used in cross-attention.

The output representations may be passed through classification heads to predict HOI action categories and spatial relations at a specified future time offset t. According to one aspect, a context window of 2 seconds may be utilized for the spatio-temporal transformer. Any of the object processor, the gaze processor, the pose processor, the spatio-temporal transformer, etc. may be implemented via the processor, the memory, and/or the storage drive.

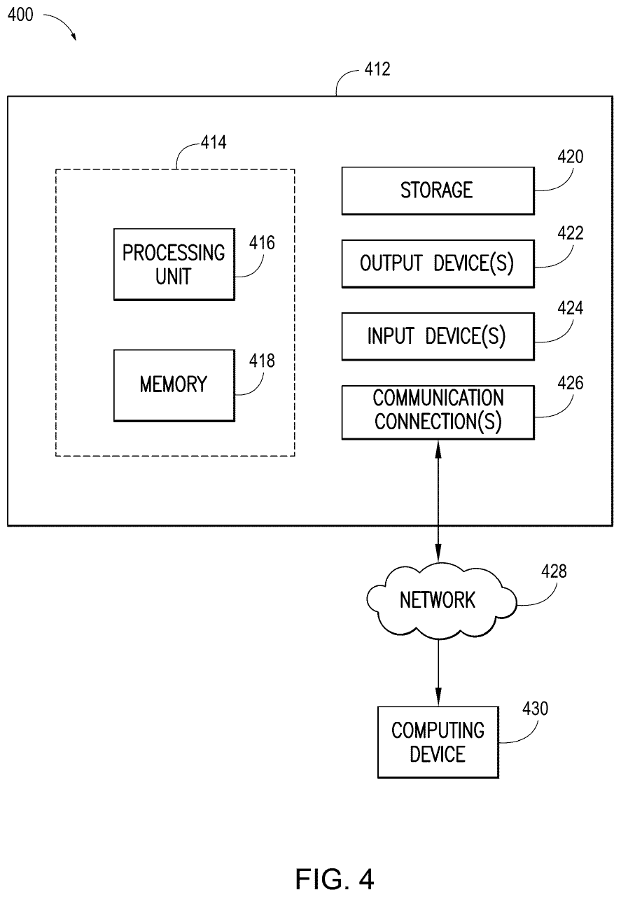

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

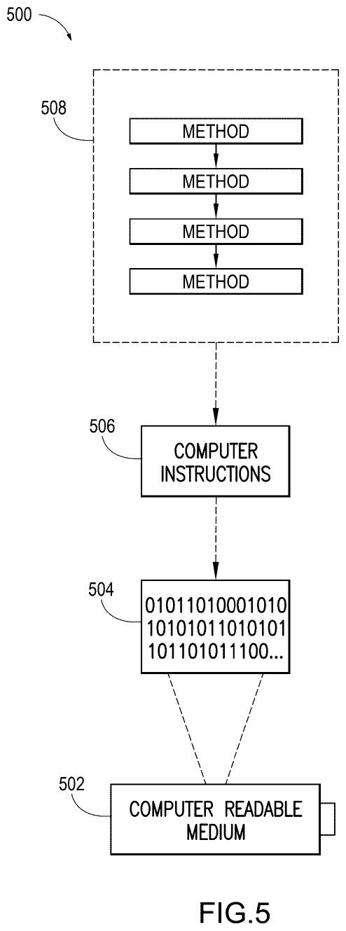

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 200 for action anticipation of FIG. 2. In another aspect, the processor-executable computer instructions 506 may be configured to implement a system, such as the system 100 for action anticipation of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for action anticipation, comprising:
a memory storing one or more instructions; and
a processor executing one or more of the instructions stored on the memory to perform:
generating a gaze embedding associated with a gaze, a pose embedding associated with a pose, and an object embedding associated with an object from an input set of image frames;
generating a joint cue based on the gaze embedding and the pose embedding and a global context token based on the gaze embedding and the object embedding; and
generating an anticipated human-object-interaction (HOI) based on a model, the joint cue, and the global context token, wherein the model is trained using ground truth data including HOI triplet annotations.

2. The system for action anticipation of claim 1, wherein the processor generates the gaze embedding based on tracking information associated with the object from the object embedding.

3. The system for action anticipation of claim 1, wherein the pose embedding includes a learned embedding component and a positional embedding component.

4. The system for action anticipation of claim 3, wherein the positional embedding component represents a spatial location associated with a keypoint.

5. The system for action anticipation of claim 3, wherein the learned embedding component represents a type of keypoint associated with a keypoint.

6. The system for action anticipation of claim 1, wherein the processor generates the joint cue by concatenating the gaze embedding and the pose embedding.

7. The system for action anticipation of claim 6, wherein the joint cue represents an attention and a body configuration.

8. The system for action anticipation of claim 1, wherein the model includes a spatial encoder and a temporal encoder.

9. The system for action anticipation of claim 8, wherein the spatial encoder refines a human-object pair representation through self-attention from the input set of image frames on a frame-by-frame basis.

10. The system for action anticipation of claim 9, wherein the temporal encoder builds an instance-level sliding window including a historical representation of the human-object pair representation.

11. A computer-implemented method for action anticipation, comprising:
generating a gaze embedding associated with a gaze, a pose embedding associated with a pose, and an object embedding associated with an object from an input set of image frames;
generating a joint cue based on the gaze embedding and the pose embedding and a global context token based on the gaze embedding and the object embedding; and
generating an anticipated human-object-interaction (HOI) based on a model, the joint cue, and the global context token, wherein the model is trained using ground truth data including HOI triplet annotations.

12. The computer-implemented method for action anticipation of claim 11, wherein the pose embedding includes a learned embedding component and a positional embedding component.

13. The computer-implemented method for action anticipation of claim 12, wherein the positional embedding component represents a spatial location associated with a keypoint.

14. The computer-implemented method for action anticipation of claim 12, wherein the learned embedding component represents a type of keypoint associated with a keypoint.

15. The computer-implemented method for action anticipation of claim 11, comprising generating the joint cue by concatenating the gaze embedding and the pose embedding.

16. The computer-implemented method for action anticipation of claim 11, wherein the model includes a spatial encoder and a temporal encoder.

17. The computer-implemented method for action anticipation of claim 16, wherein the spatial encoder refines a human-object pair representation through self-attention from the input set of image frames on a frame-by-frame basis.

18. The computer-implemented method for action anticipation of claim 17, wherein the temporal encoder builds an instance-level sliding window including a historical representation of the human-object pair representation.

19. The computer-implemented method for action anticipation of claim 11, comprising enabling a feature of a vehicle or actuating an actuator based on the anticipated HOI.

20. A system for action anticipation, comprising:
a memory storing one or more instructions; and
a processor executing one or more of the instructions stored on the memory to perform:
generating a gaze embedding associated with a gaze, a pose embedding associated with a pose, and an object embedding associated with an object from an input set of image frames;
generating a joint cue based on the gaze embedding and the pose embedding and a global context token based on the gaze embedding and the object embedding, wherein the joint cue represents an attention and a body configuration; and
generating an anticipated human-object-interaction (HOI) based on a model, the joint cue, and the global context token, wherein the model is trained using ground truth data including HOI triplet annotations.
